(19) United States
(12) Patent Application Publication
(10) Pub. No.: US 2008/0192172 A1
(43) Pub. Date: Aug. 14, 2008

(54) Discharge Lamp and Backlight Unit for Backlight a Display Device Comprising Such a Discharge Lamp

(75) Inventors: Marialuce Graziadei, Helmond (NL); Cornelis Versluijs, Eindhoven (NL); Wim Hellebrekers, Eindhoven (NL); Hendrik Mattheus Bleeker, Eindhoven (NL); Jorgen Meeusen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,641

(22) PCT Filed: Mar. 8, 2006
(86) PCT No.: PCT/IB2006/050726

§ 371 Date: Sep. 25, 2007

(30) Foreign Application Priority Data
Mar. 30, 2005 (EP) 05102516.1
Oct. 25, 2005 (EP) 05109960.4

(51) Int. Cl. G02F 1/13357; H01J 17/04; H01J 1/62

(52) U.S. Cl. 349/61; 313/631; 313/491

(57) ABSTRACT

The invention relates to a discharge lamp, comprising a light-transmissive discharge vessel (2) filled with an ionisable substance (3), and at least two electrodes (4) connected to said vessel, between which electrodes a discharge extends during lamp operation, wherein at least one electrode is adapted for capacitive coupling of HF electrical energy to said ionisable substance, and is characterised in that said discharge vessel part which comprises said capacitive electrode is shaped such that it has an increased surface area with respect to the remaining part of the discharge vessel. The invention also relates to a backlight module for backlighting a display device comprising at least one discharge lamp according to the invention. The invention further relates to a display device provided with at least one backlight module according to the invention.

The invention relates to a discharge lamp, comprising a light-transmissive discharge vessel filled with an ionisable substance, and at least two electrodes connected to said vessel, between which electrodes a discharge extends during lamp operation along an axial distance, wherein at least one electrode is adapted for capacitive coupling of HF electrical energy to said ionisable substance. The invention also relates to a backlight module for backlighting a display device, in particular an LCD unit, comprising at least one discharge lamp according to the invention. The invention further relates to a display device, in particular an LCD unit, provided with at least one backlight module according to the invention.

Hot cathode fluorescent lamps (HCFL) are well-known to backlight display devices, such as liquid crystal displays (LCD), and for other applications. Typically, a high frequency voltage with a frequency ranging from between 20 kHz to 100 kHz for instance is supplied to a discharge space within a discharge vessel or tube of the HCFL, forming a discharge resulting in generation of electromagnetic radiation as a result of which a display device can be illuminated. A HCFL however requires that its hot cathode must be kept at increased temperature permanently, even when the HFCL is temporarily turned off, in order to secure instantaneous correct functioning of the lamp after switching it on again. The need to continuously power the HCFL is unfavourable from an energetically point of view. To overcome this problem it is preferred nowadays to use cold cathode fluorescent lamps (CCFL) or alternatively external electrode fluorescent lamps (EEFL). These do not require continuous powering during a state of temporary standby of the lamp, as a result of which an LCD can be illuminated relatively economically. A EEFL usually comprises a discharge vessel of a suitable glass material, which vessel is provided at its ends with conductive coatings. The conductive coatings function as capacitive electrodes, between which a discharge extends during lamp operation along the axial distance between both ends. In the known EEFL, the conductive coatings cover a substantial circumferential outer part of the discharge vessel, leading to two non-lighting ends and hence a reduced effective lumen output. Moreover, the use of conductive surface coatings at the ends entails large power losses there, which leads to substantial warming of the surface. Both phenomena are major drawbacks of the known EEFL's.

It is an object of the invention to provide a discharge lamp with an improved lumen output and less warming up problems when compared to the known EEFL.

This object can be achieved by providing a discharge lamp according to the preamble, characterised in that said discharge vessel part which comprises said capacitive electrode is shaped such that it has an increased surface area per unit of axial distance with respect to the remaining part of the discharge vessel. By adopting the shapes according to the invention the contact area between the electrode part of the discharge vessel and said capacitive electrode is increased. Apart from leading to a better containment of the warming up, the capacity of the electrode is also increased substantially. Very beneficially, this does not go at the expense of lumen output either, since indeed an improved containment of heat and capacity is reached simultaneously with a more compact electrode design. The axial distance covered by the capacitive electrodes preferably provided at the ends of the discharge vessel is substantially smaller than for the known EEFL with the same or similar properties.

Preferably, the discharge vessel is formed by a fluorescent tube, wherein said discharge vessel part having an increased surface area per unit of axial distance comprises an end surface of said tube. In such a preferred embodiment, the discharge lamp comprises a phosphor coating for converting UV light generated within said vessel into visible light, said phosphor coating being applied onto a substantial part of the inner surface of the discharge vessel. More preferably, the inner surface of the discharge vessel is completely covered by said phosphor coating. Since coupling the presence of the parts having an increased surface area per unit of axial distance leads to an increased inner surface area of the discharge vessel as well, the applicable amount of phosphor coating can also be increased, leading to an increased conversion of UV light into visible light, and hence an improved lumen output.

In the discharge lamp according to the invention it is conceivable to apply different types of electrodes, wherein at least one electrode is adapted for capacitive coupling of HF electrical energy into the ionisable substance, and wherein another electrode may for example be formed by a conventional hot cathode, thereby resulting in a hybrid type of lamp. However, in this latter embodiment the hot cathode needs to be kept at increased temperature permanently during backlight scanning as elucidated above, which is unfavourable from an economic point of view. It is therefore preferred that each electrode is adapted for capacitive coupling of HF electrical energy to said ionisable substance, which leads to a discharge lamp which functions energetically relatively advantageously, and with which, moreover, a significantly improved lumen output can be realised with respect to conventional EEFL lamps.

Preferably, the discharge vessel parts having an increased surface area per unit of axial distance are positioned at opposite ends of the discharge vessel to maximise the length of the discharge arc generated within said vessel between the electrodes. This also maximizes the ratio of illumination length.

In a preferred embodiment of the invention the capacitive electrode comprises a conductive material provided at the increased surface area part of the discharge vessel at the side opposite from the ionisable substance. In this way, a capacitor is created by forming a laminate of the (conducting) ionisable and/or ionised substance, the non-conducting discharge vessel acting as a dielectric, and the conducting electrode. Said electrode can thereby be formed by a conductive coating, though it is also conceivable to apply other types of electrodes, such as metal sheets or more rigid conducting elements. In a particularly preferred embodiment, the capacitive electrode comprises a conductive material provided on the increased surface area part of the discharge vessel at the side opposite from the ionisable substance. Placing the electrode on the surface of the vessel, i.e. in intimate contact therewith, instead of placing it at the vessels surface, allows for a better contact between electrode and dielectric.

A preferred discharge lamp has a discharge vessel comprising at least one cavity, containing the increased surface area part. In a particularly preferred embodiment the at least one cavity is provided at one or both ends of the discharge vessel, and extends substantially in the axial direction of the vessel. Commonly, the discharge vessel is filled by means of an exhaust tube which is connected to an end surface of the discharge vessel. After filling the discharge vessel, the exhaust tube is sealed. The preferred embodiment has the additional advantage that at least part of said exhaust tube may be located in the cavity, which prevents undesirable protrusion of said exhaust tube with respect to the discharge vessel. Moreover, preferably an outer surface of said exhaust tube is at least partially covered by an electrode to increase the capacity of the capacitor formed by the aforementioned three layer laminate. The capacity of the capacitor can thus be increased without sacrificing light emitting surface, i.e. by keeping the non-lighting ends as small as possible.

It turns out that the capacity (C) of the laminated capacitor formed by the (conducting) ionisable and/or ionised substance, the non-conducting discharge vessel acting as a dielectric, and the conducting electrode, can be calculated by ε₀×εᵣ×A/d, wherein ε₀ and εᵣ are dielectric constants, A represents the contact surface between the different layers, and d represents the thickness of the intermediate dielectric layer. According to the invention, it is therefore advantageous to maximise the contact surface area between the electrode and the discharge vessel. This enlarged surface area may be achieved at the outside of the discharge vessel and/or within the cavity.

It may be clear that the person skilled in the art has several options available to him/her for dimensioning and designing such an increased surface area part. Besides increasing the contact surface area between the electrode and the discharge vessel, it is also advantageous to reduce the thickness (d) of the discharge vessel, at least at the increased area part of the discharge vessel, which holds the capacitive electrode. In a preferred embodiment of the invention the discharge lamp is characterised in that the increased surface area part of the discharge vessel comprises an axisymmetrical body with increased diameter. In such an embodiment the discharge vessel, which may for instance be an elongated glass tube with about constant diameter, is enlarged in diameter at its ends, gradually and/or stepwise. In another preferred embodiment, the increased surface area part of the discharge vessel comprises an axisymmetrical body with an undulated surface and/or with axially spaced alternating parts of varying diameter. A further preferred discharge lamp comprises an increased surface area part of the discharge vessel in the form of a ball shaped body. As already noted above the increased surface area part may be located at the outside of the discharge vessel, in which case it actually forms part of the outer surface of the vessel. Another possibility is to locate the increased surface area part within the at least one cavity of the discharge vessel, in which case it actually forms part of the inner surface of the at least one cavity.

In a particularly preferred embodiment, the discharge lamp of the invention is provided with an increased surface area discharge vessel part in the form of a multiplicity of, preferably axially extending, cavities and protrusions within the at least one cavity. Preferred axially extending cavities and protrusions are about cylindrical in cross-section. Other preferred cross-sections of the axially extending cavities and protrusions are star shaped. The cavities and protrusions may be distributed over the cross-section of the at least one cavity in a regular or irregular fashion. A preferred embodiment comprises axially extending cavities and protrusions ordered in a concentric fashion.

All embodiments discussed above provide a discharge lamp with an improved lumen output and less warming up problems when compared to the known EEFL. However heat conduction may further be improved by another preferred embodiment in which the increased surface area part of the discharge vessel comprises a multiplicity of axially extending protrusions of a solid conducting material, coated with a dielectric material. In this embodiment, the protrusions act as electrode. The solid conducting material may be any material suitable for this purpose. Preferred materials include metals such as aluminium and copper, or polymers filled with conductive particles, and so on. To allow generation of a discharge arc within the discharge vessel, preferably the discharge lamp further comprises a HF source electrically coupled to the capacitive electrode or electrodes. A very suitable coupling between HF source and capacitive electrode may be achieved by connecting the multiple axially extending protrusions of the solid conducting material to a base plate of conducting material. This base plate then acts as end plate to the entire discharge vessel.

In a preferred embodiment the discharge lamp according to the invention comprises protrusions which are cylindrically shaped. Particularly preferred protrusions are conically shaped, whereby the tip of the cone for each electrode is directed towards the inner gas volume, contained in the discharge vessel. This embodiment has the advantage that at low power, discharge takes place at the tip region and heat is conducted away from this tip region easily towards the external parts of the lamp. Moreover at high power, there is ample surface available (the base region of the cone) for discharge, which surface in addition is easily accessible.

The invention also relates to a discharge vessel for use in a discharge lamp according to the invention as described above, said discharge lamp having a part which comprises a capacitive electrode, which part is shaped such that it has an increased surface area with respect to the remaining part of the discharge vessel. The advantages and preferred embodiments of the discharge vessel according to the invention have been elucidated above and will not be repeated here.

The invention further relates to a backlight module for backlighting a display device, in particular an LCD unit, comprising: holding means for holding at least one discharge lamp according to the invention, and supply means for energizing said discharge lamp. Preferably, said holding means are adapted for holding multiple discharge lamps according to the invention.

Moreover, the invention relates to a display device, in particular an LCD unit provided with at least one backlight module according to the invention. Besides LCD's all kinds of displays can be used which require active illumination by one or more discharge lamps according to the invention.

The invention can further be illustrated by way of the following non-limitative embodiments, wherein:

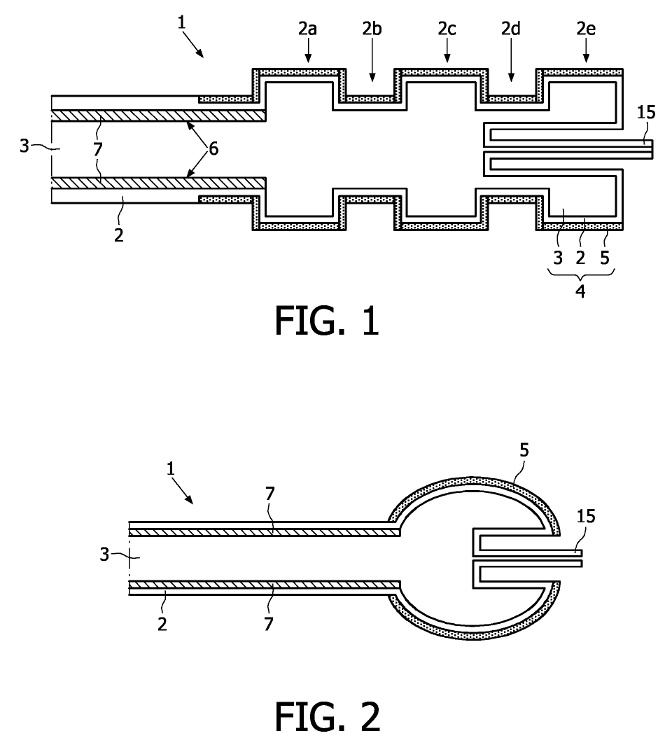

FIG. 1 shows a side view of part of a first embodiment of a fluorescent lamp according to the invention,

FIG. 2 shows a side view of part of a second embodiment of a fluorescent lamp according to the invention,

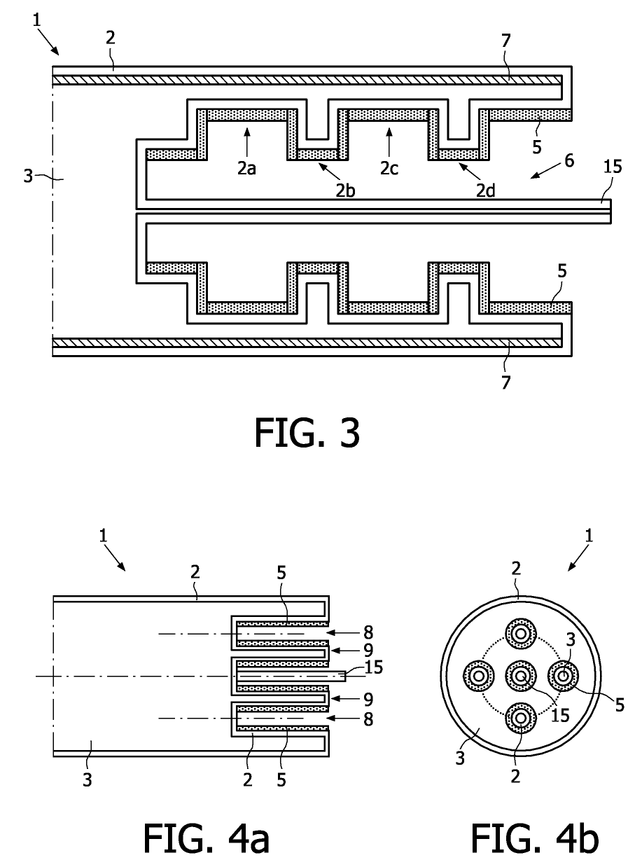

FIG. 3 shows a side view of part of a third embodiment of a fluorescent lamp according to the invention,

FIG. 4 shows a side view of part of a fourth embodiment of a fluorescent lamp according to the invention,

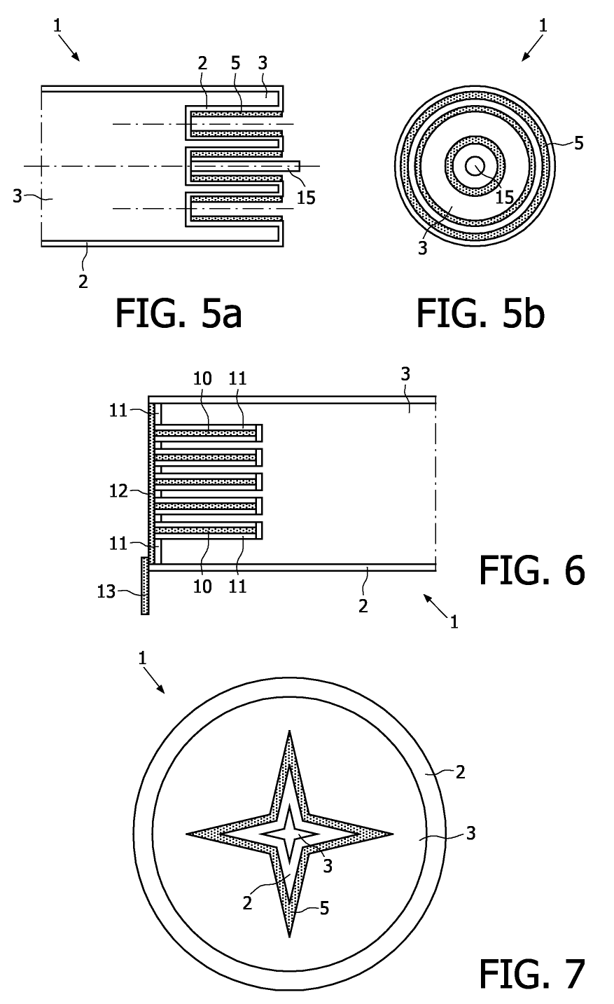

FIG. 5 shows a side view of part of a fifth embodiment of a fluorescent lamp according to the invention, and

FIG. 6 shows a side view of part of a sixth embodiment of a fluorescent lamp according to the invention, and

FIG. 7 shows a cross section of an alternative embodiment of a discharge lamp according to the invention.

FIG. 1 shows a side view of part of a first embodiment of a fluorescent lamp 1 according to the invention. The lamp 1 comprises an elongated substantially cylindrical discharge vessel 2 made of glass and filled with an ionisable substance 3, such as a mixture of mercury with a noble gas. Discharge vessel 2 is filled by means of an exhaust tube 15 which is connected to an end surface of the discharge vessel 2. After filling the discharge vessel 2, exhaust tube 15 is sealed. At least two capacitive electrodes 4 (only one is shown in the figures) are connected to said vessel 2, between which electrodes 4 a discharge extends during lamp operation along an axial distance. The axial direction runs about parallel to the vessel walls 2. The capacitive electrodes 4 are adapted for capacitive coupling of HF electrical energy to said ionisable substance 3. A capacitive electrode 4 is formed by a conducting layer 5, such as a metal, in particular copper, thereby forming together with the vessel wall 2 and the ionisable substance 3 a capacitive coupling for transferring HF electrical energy to said ionisable substance 3.

The discharge vessel part which comprises said capacitive electrode 4 is shaped such that it has an increased surface area (per unit of axial distance) with respect to the remaining part of the discharge vessel 2. In the embodiment shown in FIG. 1, the increased surface area has been realised by shaping said part of the vessel wall 2 as an axisymmetrical body with axially spaced alternating parts 2a, 2b, . . . of varying diameter. In FIG. 1 the diameter of the wall parts is alternating between two diameter values. However a gradually increasing diameter is also possible. Since the capacitive electrode 4 extends over a limited axial distance, a larger inner curved surface 6 of said discharge vessel 2 can be covered completely with a phosphor coating 7 for converting UV light generated within said vessel 2 into visible light thereby leading to an improved lumen output with respect to conventional capacitive coupled fluorescent lamps.

In the embodiment shown in FIG. 2, the increased surface area part of the discharge vessel 2 comprises a ball shaped body, with, viewed from left to right, a gradually increasing and then decreasing diameter.

FIG. 3 shows another embodiment of the discharge lamp according to the invention in which the discharge vessel 2 comprises at least one cavity 6, which contains the increased surface area part. In the embodiment shown the increased surface area part is shaped as in the embodiment of FIG. 1, i.e. as axisymmetrical body with axially spaced alternating parts 2a, 2b, . . . of varying diameter. Locating the increased surface area part at the inside of the cavity 6 allows to cover a still larger surface of the vessel 2 with phosphor coating 7.

FIG. 4 shows another embodiment of the discharge lamp 1 according to the invention. In this embodiment the increased surface area part of the discharge vessel 2 comprises a multiplicity of axially extending cavities 8 and protrusions 9. The cavities 8 and protrusions 9 are build up of vessel wall material 2, onto which a coating of a conductive material 5, for instance a metal, has been applied. A possible cross-section of such an embodiment is depicted in FIG. 4(b), which shows that the axially extending cavities 8 and protrusions 9 are cylindrical.

FIG. 5 shows another embodiment of the discharge lamp 1 according to the invention. In this embodiment the increased surface area part of the discharge vessel 2 again comprises a multiplicity of axially extending cavities 8 and protrusions 9. As in the embodiment of FIG. 4, the cavities 8 and protrusions 9 are build up of vessel wall material 2, onto which a coating of a metal 5 has been applied. A possible cross-section of the present embodiment is depicted in FIG. 5(b), which shows that the axially extending cavities 8 and protrusions 9 are arranged in a concentric pattern. Other cross-sections may be adopted however, such as the star shaped cross-section, shown in FIG. 7.

A particularly preferred embodiment of the discharge lamp according to the invention is shown in FIG. 6. In this lamp 1, the increased surface area part of the discharge vessel 2 comprises a multiplicity of axially extending protrusions 10 of a solid conducting material, coated with a dielectric material 11. The solid conductive material is preferably a metal such as copper, while the dielectric material is preferably glass. The protrusions are attached to a conductive base plate 12, which is connected to an electrical supply through connector 13. This embodiment prevents overheating of the discharge area by making use of the high conductive properties of the metal protrusions 10 and of the metal plate 12. Due to the good thermal conduction of both element series 12 and element 13, the heat generated by the lamp 1 can readily be directed to the external parts of the lamp. In a typical process to manufacture this embodiment, a series of metal pins 10 are soldered onto a metal plate 12. The metal pins 10 and plate 12 are then covered with the dielectric glass layer 11 by letting molten glass flow onto it. It is clear that, just as in the embodiments shown in FIGS. 4 and 5, the protrusions 10 may have several cross-sections, such as cylindrical. Another preferred embodiment has conically shaped protrusions with a larger base—the part closest to the plate 12—than top part.

It should be noted that the above-mentioned embodiments illustrate rather than limit the invention, and that those skilled in the art will be able to design many alternative embodiments without departing from the scope of the appended claims.

1. Discharge lamp, comprising:
a light-transmissive discharge vessel (2) filled with an ionisable substance (3), and
at least two electrodes (4) connected to said vessel, between which electrodes a discharge extends during lamp operation along an axial distance, wherein at least one electrode is adapted for capacitive coupling of HF electrical energy to said ionisable substance, characterised in that a part of said discharge vessel which comprises said capacitive electrode is shaped such that it has an increased surface area (per unit of axial distance) with respect to the remaining part of the discharge vessel.

2. Discharge lamp according to claim 1, characterised in that the capacitive electrode comprises an electrically conductive material provided at the increased surface area part of the discharge vessel at the side opposite from the ionisable substance.

3. Discharge lamp according to claim 1, characterised in that the capacitive electrode comprises an electrically conductive material provided on the increased surface area part of the discharge vessel at the side opposite from the ionisable substance.

4. Discharge lamp according to claim 1, characterised in that each electrode is adapted for capacitive coupling of HF electrical energy to said ionisable substance.

5. Discharge lamp according to claim 1, characterised in that the discharge vessel comprises at least one cavity (6), containing the increased surface area part.

6. Discharge lamp according to claim 1, characterised in that the increased surface area part of the discharge vessel comprises an axisymmetrical body with an undulated surface.

7. Discharge lamp according to claim 1, characterised in that the increased surface area part of the discharge vessel comprises an axisymmetrical body with axially spaced alternating parts (2a, 2b, 2c, 2d, 2e) of varying diameter.

8. Discharge lamp according to claim 1, characterised in that the increased surface area part of the discharge vessel comprises a ball shaped body.

9. Discharge lamp according claim 1, characterised in that the increased surface area part of the discharge vessel comprises a multiplicity of axially extending cavities (8) and protrusions (9).

10. Discharge lamp according to claim 9, characterised in that the axially extending cavities and protrusions are cylindrical.

11. Discharge lamp according to claim 9, characterised in that the axially extending cavities and protrusions have a star shaped cross-section.

12. Discharge lamp according to claim 9, characterised in that the axially extending cavities and protrusions are concentric.

13. Discharge lamp according to claim 1, characterised in that the increased surface area part of the discharge vessel comprises a multiplicity of axially extending protrusions (10) of a solid conducting material, coated with a dielectric material.

14. Discharge lamp according to claim 13, characterised in that the protrusions are cylindrically shaped.

15. Discharge lamp according to claim 13, characterised in that the protrusions are conically shaped.

16. Discharge lamp according to claim 1, characterised in that the discharge lamp further comprises a HF source electrically coupled to the at least one capacitive electrode.

17. Discharge lamp according to claim 1, characterised in that the discharge lamp further comprises a phosphor coating (7) for converting UV light generated within said envelope into visible light, said phosphor coating being applied onto a substantial part of an inner surface of the discharge vessel.

18. Discharge vessel for use in a discharge lamp according to claim 1, having a part which comprises said capacitive electrode, which part is shaped such that it has an increased surface area with respect to the remaining part of the discharge vessel.

19. Backlight module for backlighting a display device, comprising:
holding means for holding at least one discharge lamp according to claim 1, and
supply means for energizing said discharge lamp.

20. Display device, in particular an LCD unit, provided with at least one backlight module according to claim 19.
